(19) United States
(12) Patent Application Publication
(10) Pub. No.: US 2023/0393661 A1
(43) Pub. Date: Dec. 7, 2023

(54) REMOTE TACTILE PROVISION DEVICE, REMOTE TACTILE DATABASE, AND METHOD FOR GENERATING SAME

(71) Applicant: PSDL CO., LTD, Seongnam-si (KR)

(72) Inventor: Sung Woo CHUN, Sejong-si (KR)

(21) Appl. No.: 18/451,680

(22) Filed: Aug. 17, 2023

Related U.S. Application Data
(63) Continuation of application No. PCT/KR2021/003150, filed on Mar. 15, 2021.

(30) Foreign Application Priority Data
Feb. 19, 2021 (KR) 10-2021-0022215

(51) Int. Cl. G06F 3/01; G06F 3/0354

(52) U.S. Cl. CPC G06F 3/016; G06F 3/03543; G06F 3/014

(57) ABSTRACT

A remote tactile provision device according to an embodiment of the present invention may comprise: a tactile signal reception unit which, when a specific object is selected, receives a tactile signal of the specific object; and a tactile signal application unit which provides, to a human body, the tactile signal received by the tactile signal reception unit.

### CROSS-REFERENCE TO RELATED APPLICATIONS

This application is a continuation of Application No. PCT/KR2021/003150, filed on Mar. 15, 2021, which in turn claims the benefit of Korean Patent Application No. 10-2021-0022215, filed on Feb. 19, 2021, the disclosures of which are incorporated by reference into the present application.

### TECHNICAL FIELD

The present invention relates to a remote tactile provision device, a remote tactile database, and a method for generating the same, and more particularly, to a remote tactile provision device, a remote tactile database, and a method for generating the same, capable of remotely receiving a tactile sensation.

### BACKGROUND ART

Among the five senses that a human has, a tactile sensation refers to a sensation detected by tactile receptors distributed on the skin, in which a tactile sense is distributed throughout the body, and the distribution is particularly dense a finger portion.

There are seven tactile-associated receptors in the skin, and among the seven tactile-associated receptors, four respond to external mechanical stimulation, one responds to pain, and two respond to a temperature (cold and warm).

Among the four receptors that respond to mechanical stimulation, two respond sensitively to pressure signals (static stimulation), and the remaining two respond sensitively to vibration signals (dynamic stimulation).

The tactile receptors that are sensitive to a static force include Merkel (sensitive to a vertical pressure) and Ruffini (sensitive to stretching), which are referred to as slow-adaptive (SA) types.

The tactile receptors that are sensitive to a dynamic force include Meissner (sensitive to a low-frequency (<50 Hz) vibration) and Passinian (a high frequency (<500 Hz)), which are referred to as fast-adaptive (FA) types.

As a result, a human may perceive a tactile sensation for external physical stimulation by using the four receptors that respond to the mechanical stimulation described above.

When external stimulation is applied to the skin, the tactile receptors may respond according to characteristics of the stimulation, and when stimulation of a predetermined threshold or more is applied, the stimulation may be converted into a pattern of an electrical signal (action potential; AP) that may be transmitted within nerves of the human according to strength and an interval of the stimulation.

The tactile receptors that are sensitive to the static force may form an electrical signal pattern in which APs are densely distributed as a magnitude of a pressure and a degree of stretching increase. In other words, since individual APs have the same height, the human may feel strength of an external force at an interval of the individual APs.

Meanwhile, regarding the dynamic force (vibration), APs may be generated upon a time of contact and upon a time of non-contact.

AP signal patterns dependent on SA and FA may be generated in response to external stimulation, respectively, and corresponding electrical signals may be independently transmitted to the thalamus along other peripheral nerves, and sequentially processed by the brain so that a tactile sensation may be sensed.

Therefore, if a human may virtually synthesize an AP pattern generated by contact with an external object to input the AP pattern to nerves of the human, the human may feel a corresponding tactile sensation.

Accordingly, there is a need for a method for generating an AP pattern that is identical to an AP pattern in a case where the skin makes contact with a tactile object by applying a vibration and a sound wave to the skin and transmitting the generated AP pattern, and a method for externally generating an AP pattern generated when a tactile object makes contact and transmitting the generated AP pattern by directly stimulating nerves in an electrical or optical manner.

Conventionally, research has been conducted to transmit a virtual tactile sensation by transmitting a tactile electrical signal to a user with a vibration. However, since this is merely a virtual tactile sensation, which is different from an actual tactile sensation, the virtual tactile sensation is insufficient to be considered as a remote tactile sensation.

Accordingly, the present inventors have invented a technology capable of remotely providing a tactile sensation itself.

### DISCLOSURE

### Technical Problem

One technical object of the present invention is to provide a remote tactile provision device, a remote tactile database, and a method for generating the same, capable of providing a realistic tactile sensation of an object even when there is no actual touch of the object.

One technical object of the present invention is to provide a remote tactile provision device, a remote tactile database, and a method for generating the same, capable of providing a tactile signal having a high degree of similarity to an AP pattern sensed by a human body.

Technical objects of the present invention are not limited to the above-described objects, and may be clarified by the following description.

### Technical Solution

According to one embodiment of the present invention, a remote tactile provision device may include: a tactile signal reception unit for receiving a tactile signal of a specific object when the specific object is selected; and a tactile signal application unit for providing the tactile signal, which is received by the tactile signal reception unit, to a human body.

According to one embodiment, the tactile signal may selectively stimulate, among a tactile receptor of the human body and a nerve connected to the tactile receptor, the nerve except for the tactile receptor.

According to one embodiment, the tactile signal may include a first electrical signal associated with a pressure, and a second electrical signal associated with a vibration.

According to one embodiment, the first electrical signal may be configured as a train including at least one electrical signal pulse, and the tactile signal application unit may increase an interval between electrical signal pulses constituting the first electrical signal in a predetermined scheme as a time required for the provision to the human body increases.

According to one embodiment, the remote tactile provision device may further include a wearing unit worn on the human body, and the tactile signal application unit may be provided on an inner surface of the wearing unit.

According to one embodiment, the tactile signal reception unit may receive the tactile signal when a tactile signal request unit requests the tactile signal for the specific object.

According to one embodiment, the tactile signal application unit may be provided on one side of a mouse for controlling an indicator displayed on a display, and the tactile signal reception unit may receive the tactile signal of the specific object when a click time of the specific object indicated by the indicator is greater than or equal to a predetermined time.

According to one embodiment, the tactile signal application unit may be provided in a click unit of the mouse.

According to one embodiment, the remote tactile provision device may further include a tactile signal amplification unit for amplifying the tactile signal according to a predefined reference, and the tactile signal application unit may provide the amplified tactile signal to a skin.

According to one embodiment of the present invention, a remote tactile database may include: a tactile data set configured as a pair of information associated with an object identifier indicating at least one object and an electrical signal causing a tactile sensation of an object for each object.

According to one embodiment of the present invention, a method for generating a remote tactile database may include: a first step of sensing a signal caused from a tactile sensation of an object; and a second step of converting the sensed signal into a tactile signal, which is recognized as the tactile sensation of the object when the tactile signal is applied to a skin.

According to one embodiment, the tactile signal obtained through the conversion may selectively stimulate, among a tactile receptor of a human body and a nerve connected to the tactile receptor, the nerve except for the tactile receptor.

### Advantageous Effects

According to one embodiment of the present invention, a remote tactile provision device may include: a tactile signal reception unit for receiving a tactile signal of a specific object when the specific object is selected; and a tactile signal application unit for providing the tactile signal, which is received by the tactile signal reception unit, to a human body.

According to one embodiment, the tactile signal may selectively stimulate, among a tactile receptor of the human body and a nerve connected to the tactile receptor, the nerve except for the tactile receptor.

Accordingly, a realistic tactile sensation of an object can be remotely provided even when there is no actual touch of the object.

### DESCRIPTION OF DRAWINGS

FIG. 1 is a view showing an environment according to one embodiment of the present invention.

FIG. 2 is a view for describing a remote tactile database according to one embodiment of the present invention.

FIGS. 3 and 4 are views for describing the remote tactile database according to one embodiment of the present invention in detail.

FIG. 5 is a flowchart describing a method for generating a remote tactile database according to one embodiment of the present invention.

FIG. 6 is a view for describing a step S110 of the method for generating the remote tactile database according to one embodiment of the present invention.

FIGS. 7 and 8 are views for describing a step S120 of the method for generating the remote tactile database according to one embodiment of the present invention.

FIG. 9 is a view for describing a remote tactile provision device according to one embodiment of the present invention.

FIG. 10 is a view for describing one example of a remote tactile provision device according to one embodiment of the present invention.

FIGS. 11 to 13 are views for describing a method for operating a remote tactile provision device according to one embodiment of the present invention.

### MODE FOR INVENTION

Hereinafter, exemplary embodiments of the present invention will be described in detail with reference to the accompanying drawings. However, the technical idea of the present invention is not limited to the embodiments described herein, but may be realized in different forms. The embodiments introduced herein are provided to sufficiently deliver the idea of the present invention to those skilled in the art so that the disclosed contents may become thorough and complete.

When it is mentioned in the present disclosure that one element is on another element, it means that one element may be directly formed on another element, or a third element may be interposed between one element and another element. Further, in the drawings, thicknesses of shapes and regions are exaggerated for effective description of the technical contents.

In addition, in various embodiments of the present disclosure, the terms such as first, second, and third are used to describe various elements, but the elements are not limited by the terms. The terms are used only to distinguish one element from another element. Therefore, an element mentioned as a first element in one embodiment may be mentioned as a second element in another embodiment. The embodiments described and illustrated herein include their complementary embodiments. Further, the term “and/or” used herein is used to include at least one of the elements enumerated before and after the term.

As used herein, expressions in a singular form include a meaning of a plural form unless the context clearly indicates otherwise. Further, the terms such as “including” and “having” are intended to designate the presence of features, numbers, steps, elements, or combinations thereof described in the present disclosure, and shall not be construed to preclude any possibility of the presence or addition of one or more other features, numbers, steps, elements, or combinations thereof. In addition, the term “connection” used herein is used to include both indirect and direct connections of a plurality of elements.

In addition, the term such as “ . . . unit”, “ . . . er”, or “module” described in the present disclosure refers to a unit for processing at least one function or operation, which may be implemented through hardware, software, or a combination of hardware and software.

Further, in the following description of the present invention, detailed descriptions of known functions or configurations incorporated herein will be omitted when they may make the gist of the present invention unnecessarily unclear.

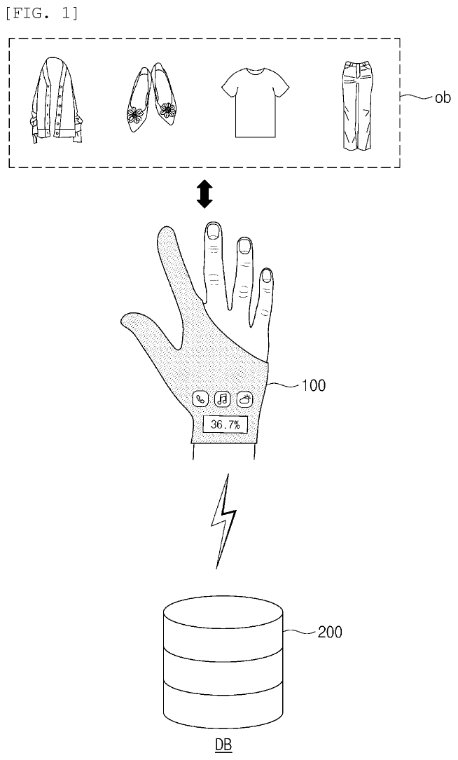

FIG. 1 is a view showing an environment according to one embodiment of the present invention.

Referring to FIG. 1, a remote tactile provision device 100 may provide a tactile sensation of an object ob.

According to the present disclosure, the object may refer to an object that provides a tactile sensation. For example, as shown in FIG. 1, the object may be a sweater, shoes, a T-shirt, pants, and the like, and anything to remotely transmit a tactile sensation may correspond to the object.

According to one example, the object may be displayed on a display. In this case, the remote tactile provision device according to one embodiment may provide a tactile sensation of a specific object to a user when the specific object on the display is selected.

According to another example, even when the object is not displayed on the display, the remote tactile provision device according to one embodiment may provide a tactile sensation of a specific object according to a request of a user.

The remote tactile provision device 100 according to one embodiment may virtually provide a tactile sensation, such that a feeling in a case where a tactile recognition system of a human body actually touches the object may be directly provided to a skin. For example, an AP spike pattern corresponding to the tactile sensation of the specific object may be directly provided to the human body, so that the tactile sensation may be transmitted regardless of the presence or absence of an actual object touch.

According to one embodiment, a remote tactile signal may include at least one of an electrical signal, an ultrasonic signal, an optical signal, and a laser signal. Hereinafter, for convenience of description, it will be assumed that the remote tactile signal is an electrical signal.

Referring continuously to FIG. 1, a remote tactile database 200 according to one embodiment may store and manage a tactile signal for each object in advance. For example, the remote tactile database may store and manage tactile sensations of a sweater, shoes, a T-shirt, and pants shown in FIG. 1 in advance.

As described above, the object shown in FIG. 1 is merely one example, so that the tactile signal may be stored and managed for each material such as plastic, paper, wood, and rubber, and furthermore, tactile signals according to a content of a component for each material may be further stored and managed.

In other words, the remote tactile database 200 may standardize and manage countless materials according to a predetermined reference. Since tactile signals of the standardized materials are selectively stored and managed, convenience of constructing a database may be improved.

Accordingly, when the remote tactile provision device 100 according to one embodiment requests the tactile signal of the specific object from the remote tactile database 200, the remote tactile database 200 may provide the tactile signal of the specific object, which is previously stored and managed, to the remote tactile provision device 100. In other words, the remote tactile provision device 100 may receive a tactile signal of a sweater from the remote tactile database 200 to provide the tactile signal to the user.

Hereinafter, one embodiment of the present invention will be described in detail with reference to each of the drawings.

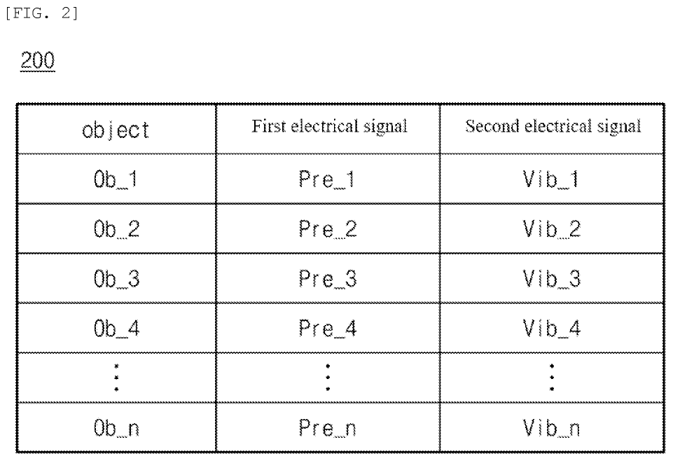

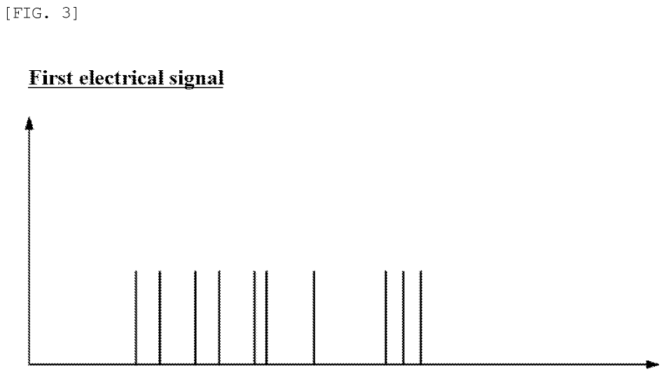

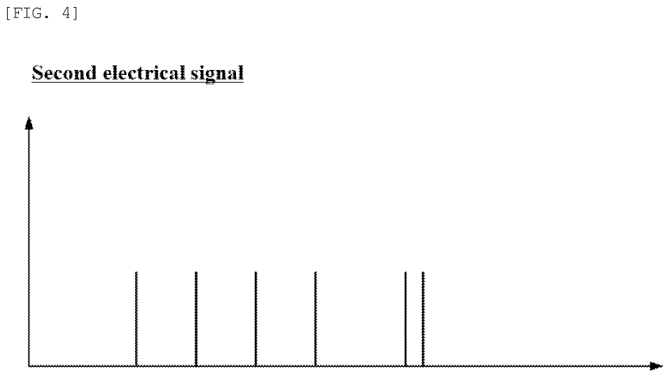

FIG. 2 is a view for describing a remote tactile database according to one embodiment of the present invention, and FIGS. 3 and 4 are views for describing the remote tactile database according to one embodiment of the present invention in detail.

As described above, it will be assumed that the remote tactile database 200 stores and manages an electrical signal as an example of a tactile signal. Referring to FIG. 2, the remote tactile database 200 may store and manage a tactile signal for each specific material in advance. In this case, the tactile signal for each object may be stored and managed as a first electrical signal and a second electrical signal. The first and second electrical signals may be signals capable of causing an AP pattern, which is spiked when a specific object is actually touched, in the human body.

A tactile sensation provided by the object may be configured as a combination of a pressure sense and a vibration caused by a surface of the object. When taking the above point into consideration, as shown in FIG. 3, the first electrical signal may be an electrical signal corresponding to a pressure caused on the surface of the object. As shown in FIG. 4, the second electrical signal may be an electrical signal corresponding to a vibration caused on the surface of the object. In this case, the first and second electrical signals may cause an AP pattern, which is spied when a specific object is actually touched, in the human body.

In other words, the remote tactile database 200 according to one embodiment may store and manage an electrical signal corresponding to a tactile sensation of a first object ob_1 as a first electrical signal Pre_1 and a second electrical signal Vib_1. In the same way, the remote tactile database 200 may store and manage electrical signals for tactile sensations of second to n^{th} objects.

The remote tactile database 200 according to one embodiment may provide the first electrical signal Pre_1 and the second electrical signal Vib_1 to the remote tactile provision device 100 when a request for a tactile signal for a specific object, for example, ob_1, is received from the remote tactile provision device 100.

Meanwhile, in a state where the remote tactile database 200 stores and manages a tactile signal for each standardized material in advance, when a tactile signal of a non-standardized object is requested, the remote tactile database 200 may provide a tactile signal of the requested object through a combination of tactile signals for each material, which are previously stored and managed.

For example, in a state where the remote tactile database 200 stores and manages tactile signals of clothes famed of 100% nylon fabric and clothes formed of 100% polyester fabric in advance, when a request for a tactile signal of mixed clothes formed of 70% nylon and 30% polyester is received, the remote tactile database 200 may regenerate a tactile signal in consideration of a mixing ratio of materials and provide the tactile signal.

Hereinafter, a method for generating a remote tactile database 200 according to one embodiment of the present invention will be described.

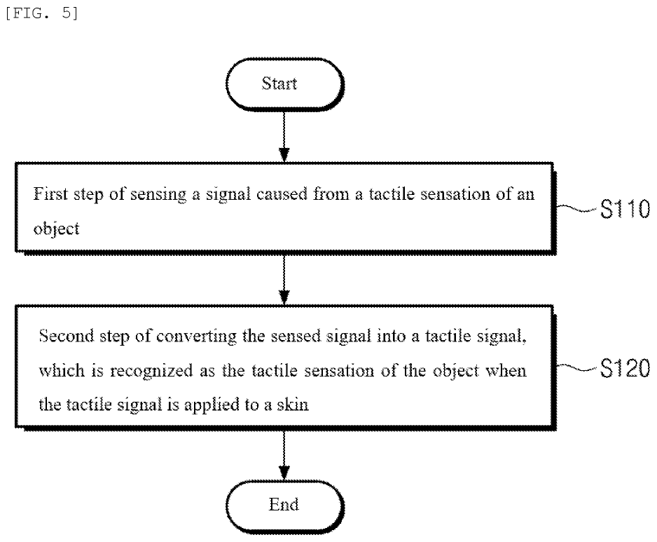

FIG. 5 is a flowchart describing a method for generating a remote tactile database according to one embodiment of the present invention.

Referring to FIG. 5, a method for generating a remote tactile database according to one embodiment may include at least one of a first step S110 of sensing a signal caused from a tactile sensation of an object, and a second step S120 of converting the sensed signal into a tactile signal, which is recognized as the tactile sensation of the object when the tactile signal is applied to a skin. Hereinafter, each of the steps will be described in detail.

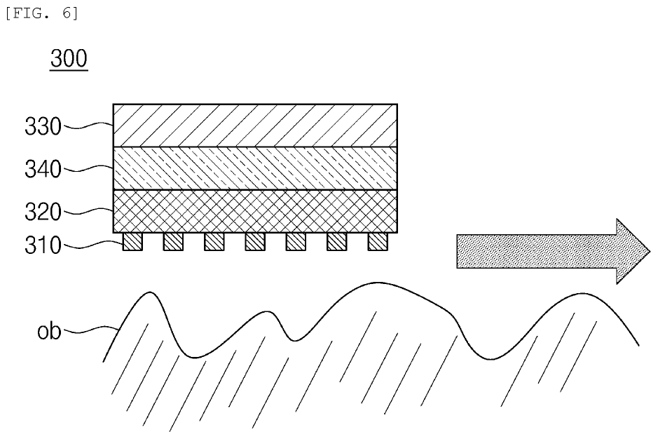

In the step S110, the signal caused from the tactile sensation of the object may be sensed. To this end, a remote tactile database generation device may be used, which will be described in detail with reference to FIG. 6. FIG. 6 is a view for describing a step S110 of the method for generating the remote tactile database according to one embodiment of the present invention.

As shown in FIG. 6, according to one embodiment of the present invention, a remote tactile database generation device 300 may be formed to include a fine protrusion pattern 310, a vibration sensor 320, a pressure sensor 330, and a buffer layer 340.

The fine protrusion pattern 310 may be provided to directly make contact with a surface of the object ob. To this end, the fine protrusion pattern 310 may be provided on one side surface of the vibration sensor 320 facing the surface of the object ob. The fine protrusion pattern 310 may be formed by allowing a plurality of fine protrusions forming a predetermined pattern to protrude from one side surface of the vibration sensor 320. In this case, the fine protrusions may be attached to one side surface of the vibration sensor 320.

The fine protrusion pattern 310 may serve, for example, as a fingerprint of a finger, which makes direct contact with the surface of the object ob to transmit a vibration and a pressure caused by the surface of the object ob to the vibration sensor 320 and the pressure sensor 330. In other words, when the remote tactile database generation device 300 according to one embodiment of the present invention is stroked along the surface of the object ob in a state of making contact with the surface of the object ob, a vibration signal and a pressure signal caused by the surface of the object ob may be collected. In this case, the vibration signal caused by the surface of the object ob may represent a signal associated with roughness of the surface of the object ob. In addition, the pressure signal caused by the surface of the object ob may represent a signal associated with hardness of the surface of the object ob.

The vibration sensor 320 may sense the vibration signal caused by the surface of the object ob. In this case, the vibration signal caused by the surface of the object ob may be transmitted from the fine protrusion pattern 310 that makes direct contact with the surface of the object ob.

The vibration sensor 320 may be disposed on the fine protrusion pattern 310. When the remote tactile database generation device 300 is located on the surface of the object ob in order to collect the vibration signal and the pressure signal caused by the surface of the object ob, the vibration sensor 320 may make contact with the surface of the object ob by a medium of the fine protrusion pattern 310.

According to one embodiment of the present invention, the vibration sensor 320 may be configured as a sensor element that responds sensitively to a vibration without responding to a static pressure. For example, the vibration sensor 320 may be configured as a piezoelectric element or a triboelectric element.

The pressure sensor 330 may sense the pressure signal caused by the surface of the object ob. In this case, the pressure signal caused by the surface of the object ob may be sensed from deformation of the vibration sensor 320 having flexibility.

According to one embodiment of the present invention, the pressure sensor 330 may be disposed on the vibration sensor 320. When the remote tactile database generation device 300 is located on the surface of the object ob in order to collect the vibration signal and the pressure signal caused by the surface of the object ob, the pressure sensor 330 may be located farthest away from the surface of the object ob. When the surface of the object ob is considered as a reference, a structure in which the fine protrusion pattern 310, the vibration sensor 320, and the pressure sensor 330 are sequentially arranged may be formed on the surface of the object ob.

According to one embodiment of the present invention, the pressure sensor 330 may be configured as a sensor element that responds sensitively to a static pressure without responding to a vibration. For example, the pressure sensor 330 may be configured as a piezoresistive element or a capacitive element.

The buffer layer 340 may be disposed between the vibration sensor 320 and the pressure sensor 330. The buffer layer 340 may transmit the deformation of the vibration sensor 320 caused by the surface of the object ob to the pressure sensor 330. To this end, similar to the vibration sensor 320 and the pressure sensor 330, the buffer layer 340 may be formed of a material having flexibility. The buffer layer 340 may serve to prevent or minimize noise generated by an interference between the vibration sensor 320 and the pressure sensor 330, which is caused by direct contact between the sensors.

Accordingly, the remote tactile database generation device 300 described above may sense the tactile sensation for each object.

In the step S120, the sensed signal may be converted into the tactile signal, which is recognized as the tactile sensation of the object when the tactile signal is applied to the skin.

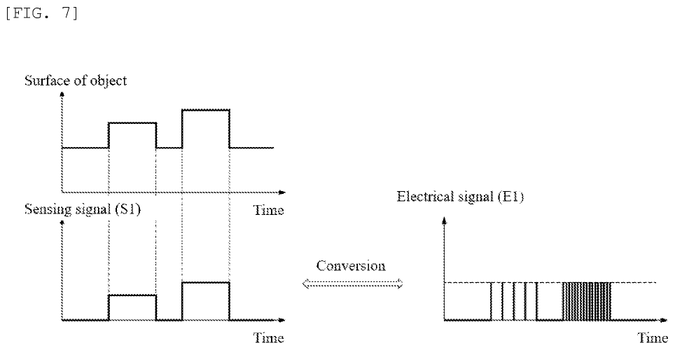

Referring to FIG. 7, the pressure sensor 330 may generate a pressure sensing signal S1 according to a pressure variation caused by the surface of the object ob. In this case, the pressure sensing signal S1 generated through the pressure sensor 330 may be converted into an electrical signal (E1) system that is actually felt by a human in a process of constructing a database with the pressure sensing signal S1. To this end, artificial intelligence learning may be applied.

In this case, electrical signals E1 may have a relatively dense interval as an absolute value of the pressure caused by the surface of the object ob increases. In this case, a plurality of electrical signal (E1) pulses may have the same intensity (i.e., magnitude).

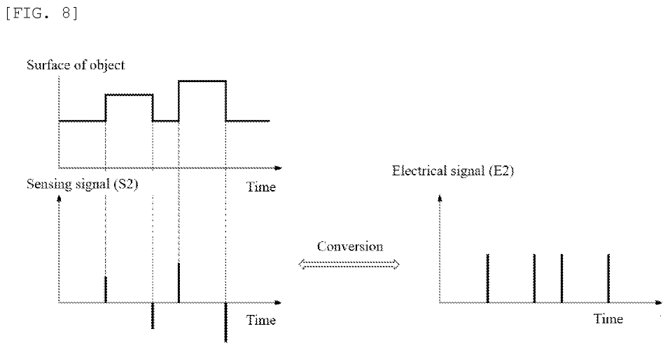

Referring to FIG. 8, the vibration sensor 320 may generate a vibration sensing signal S2 at a vibration variation point caused by the surface of the object ob. To this end, artificial intelligence learning may be applied.

In this case, the vibration sensing signal S2 generated at a plurality of vibration variation points may be converted into an electrical signal (E2) system that is actually felt by a human in a process of constructing a database with the vibration sensing signal S2.

Due to the conversion in the step S120, the electrical signal may directly stimulate a nerves without passing through a tactile receptor of the human body so as to virtually provide a realistic tactile sensation. In other words, the tactile signal stored and managed by the remote tactile database 200 may be understood as a signal that selectively stimulates, among a tactile receptor of the human body and a nerve connected to the tactile receptor, the nerve except for the tactile receptor.

As the above steps S110 and S120 are repeatedly performed for each object, the remote tactile database 200 described above may be generated. In this case, the tactile signal may be virtually synthesized through artificial intelligence. Accordingly, even a tactile sensation of a material that is not managed in the database may be provided.

In addition to the above method, the method for generating the remote tactile database may include a method for performing generation with an AP pattern applied to a human so as to be spiked, and a method for performing generation with an AP pattern applied to an animal (living body) so as to be spiked.

In more detail, the method for performing the generation with the AP pattern applied to the human so as to be spiked may include performing the generation by providing stimulation to the human and imitating an AP spike pattern of a nerve.

In more detail, the method for performing the generation with the AP pattern applied to the animal (living body) so as to be spiked may include performing the generation by providing stimulation to the animal and imitating an AP spike pattern of a nerve, and applying a result of the generation to the human. The method for performing the generation with the AP pattern applied to the animal (living body) so as to be spiked may be a scheme of simply matching and transmitting a virtual tactile sensation in a one-to-one correspondence according to the object (surface). According to the method for performing the generation with the AP pattern applied to the animal (living body) so as to be spiked, a sense of reality may be improved through deep learning.

Hereinafter, the remote tactile provision device 100 according to one embodiment of the present invention will be described.

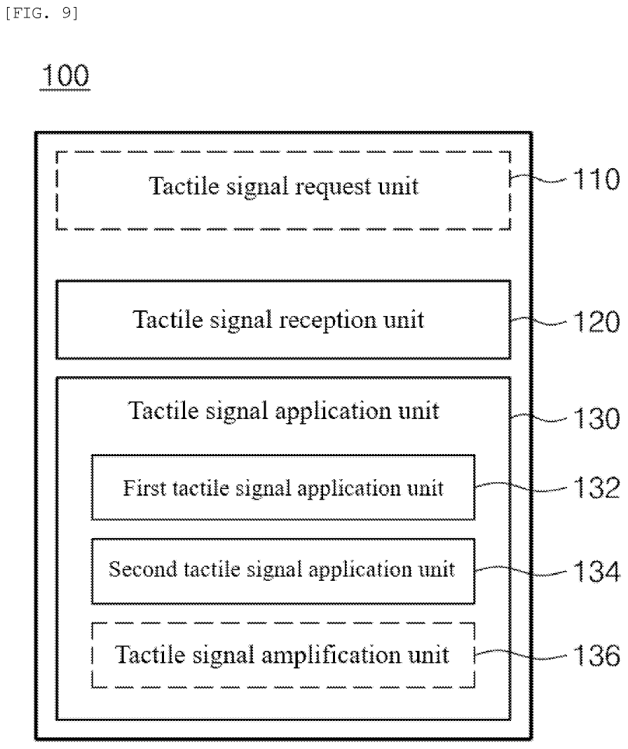

FIG. 9 is a view for describing a remote tactile provision device according to one embodiment of the present invention, and FIG. is a view for describing one example of a remote tactile provision device according to one embodiment of the present invention.

Referring to FIG. 9, according to one embodiment of the present invention, the remote tactile provision device 100 may include at least one of a tactile signal request unit 110, a tactile signal reception unit 120, and a tactile signal application unit 130.

The tactile signal request unit 110 may perform a function of requesting the tactile signal for the specific object from the remote tactile database 200 when the user desires to feel the tactile sensation for the specific object.

According to one example, when the specific object displayed on the display is selected for a predetermined time or more, or when a tactile request command is received while the specific object is selected, the tactile signal request unit 110 may request the tactile signal from the remote tactile database 200.

The tactile signal reception unit 120 may perform a function of receiving the tactile signal received from the remote tactile database 200.

The tactile signal application unit 130 may be a unit for providing the received tactile signal to the human body, for example, the skin, and may further include first and second tactile signal application units 132 and 134. The first tactile signal application unit 132 may apply the first electrical signal (see FIG. 2) associated with the pressure caused by the tactile sensation to the skin. The second tactile signal application unit 134 may apply the second electrical signal (see FIG. 2) associated with the vibration caused by the tactile sensation to the skin.

The tactile signal application unit 130 may further include a tactile signal amplification unit 136. The tactile signal amplification unit 136 may amplify the signal according to a predetermined reference in applying the tactile signal to the human body. In this case, the amplifying of the signal may mean increasing a pressure sense by allowing an interval between pulses constituting the electrical signal to be dense as well as increasing an intensity of the signal. Accordingly, even when a loss occurs in transmitting the tactile signal to the human body, the AP pattern may be spiked in the human body as in a case where an actual tactile sensation is sensed.

Meanwhile, the tactile signal application unit 130 may further consider a tactile sensation duration in applying the tactile signal to the human body. The tactile signal application unit may increase an interval between electrical signal pulses constituting the first electrical signal associated with the pressure in a predetermined scheme as a time required for the provision to the human body increases. According to a scheme in which the human body feels the tactile sensation, a pulse train interval of the first electrical signal associated with the pressure may be increased as a time required to feel the tactile sensation of the same object increases, so that this may be considered for the above configuration.

The remote tactile provision device 100 according to one embodiment of the present invention may be a device for providing a virtual tactile sensation to a human body, which may be implemented in various ways in hardware. For example, the remote tactile provision device 100 may be provided in the form of a wearable device. In this case, the tactile signal application unit 130 may be provided on an inner surface of the wearable remote tactile provision device 100.

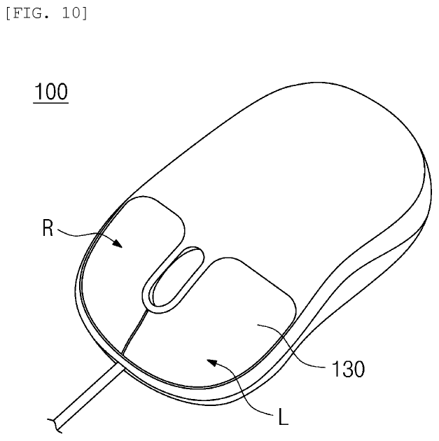

In more detail, as shown in FIG. 1, the remote tactile provision device 100 may be provided in the form of a glove. As another example, the remote tactile provision device 100 may be provided in the foam of a pad, and as shown in FIG. 10, the remote tactile provision device 100 may be provided to an existing input tool, for example, a mouse.

Referring to FIG. 10, when the remote tactile provision device 100 is formed in the mouse, the tactile signal request unit 110 may be provided in a mouse-left click unit L. In other words, when a click time of the specific object indicated by an indicator displayed on the display is greater than or equal to a predetermined time, the tactile signal request unit 110 may request the tactile signal of the indicated specific object from the remote tactile database 200. Furthermore, the tactile signal application unit 130 may also be provided in mouse-right and/or mouse-left click units R and L, which make contact with fingers. Accordingly, a virtual tactile sensation may be provided during mouse manipulation.

Hereinafter, a method for operation a remote tactile provision device according to one embodiment of the present invention will be described, in which it will be assumed that the remote tactile provision device corresponds to the example described with reference to FIG. 10. In other words, it will be assumed that the mouse serves as the remote tactile provision device 100 according to one embodiment.

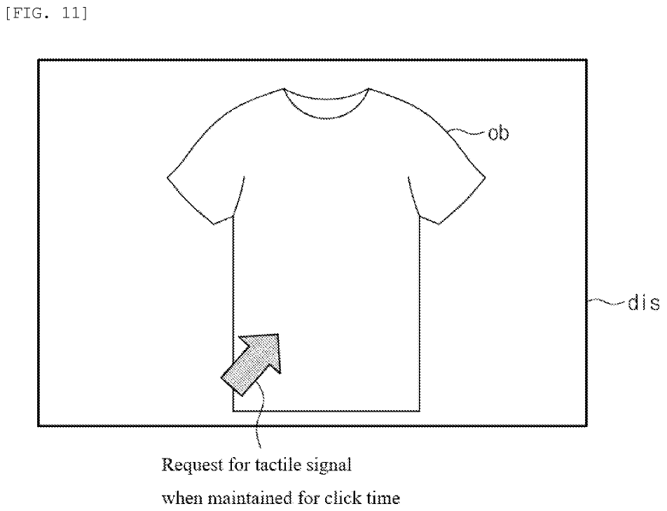

FIGS. 11 to 13 are views for describing a method for operating a remote tactile provision device according to one embodiment of the present invention.

As shown in FIG. 11, a T-shirt object ob may be displayed on a display dis. For convenience of understanding, it will be assumed that the user is shopping for a T-shirt at an online shopping mall.

When the user is curious about a texture of the T-shirt shown in FIG. 11 during the shopping, the user may press a left button of the mouse for a predetermined time while overlaying a mouse indicator on the T-shirt.

In this case, the tactile signal request unit 110 may request the texture of the T-shirt from the remote tactile database 200, and the tactile signal reception unit 120 may receive a tactile signal for reproducing a tactile sensation of the T-shirt from the remote tactile database 200 that stores and manages the tactile signal of the T-shirt in advance in the above-described method. Accordingly, the tactile signal application unit 130 may apply the tactile signal of the T-shirt to the human body.

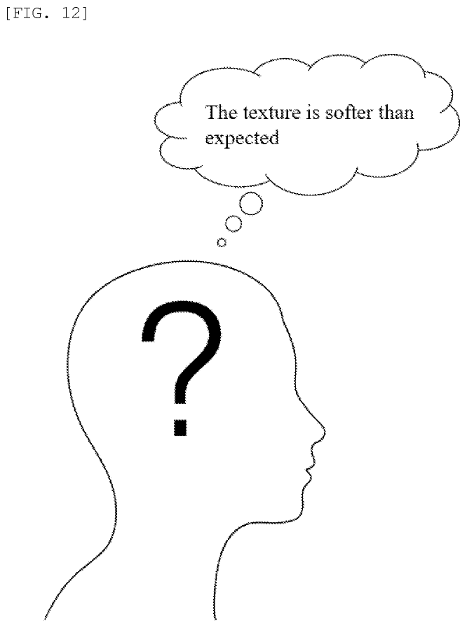

Therefore, as shown in FIG. 12, the user may feel the texture of the T-shirt as if the T-shirt was real, even without directly touching the texture.

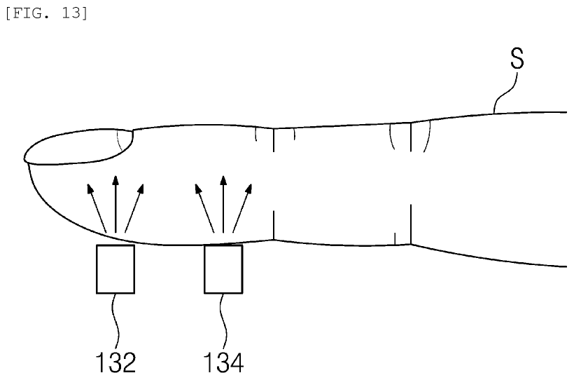

Meanwhile, referring to FIG. 13, although it is assumed that the remote tactile provision device 100 is formed in the mouse in describing the operating method according to one embodiment, when the remote tactile provision device 100 is formed in a glove, which is a wearable device, as shown in FIG. 1, the tactile signal may be provided through the first and second tactile signal application units 132 and 134 provided on an inner surface of the wearable device toward a skin S.

According to one embodiment of the present invention described above, the tactile signal provided by the remote tactile provision device may directly stimulate the nerve without passing through the tactile receptor so as to transmit the tactile sensation. Accordingly, a realistic tactile sensation may be transmitted to the human body.

Although the exemplary embodiments of the present invention have been described in detail above, the scope of the present invention is not limited to a specific embodiment, and shall be interpreted by the appended claims. In addition, it is to be understood by those of ordinary skill in the art that various changes and modifications can be made without departing from the scope of the present invention.

1. A remote tactile provision device comprising:
a tactile signal reception unit for receiving a tactile signal of a specific object when the specific object is selected; and
a tactile signal application unit for providing the tactile signal, which is received by the tactile signal reception unit, to a human body.

2. The remote tactile provision device of claim 1, wherein the tactile signal selectively stimulates, among a tactile receptor of the human body and a nerve connected to the tactile receptor, the nerve except for the tactile receptor.

3. The remote tactile provision device of claim 1, wherein the tactile signal includes a first electrical signal associated with a pressure, and a second electrical signal associated with a vibration.

4. The remote tactile provision device of claim 3, wherein the first electrical signal is configured as a train including at least one electrical signal pulse, and
the tactile signal application unit increases an interval between electrical signal pulses constituting the first electrical signal in a predetermined scheme as a time required for the provision to the human body increases.

5. The remote tactile provision device of claim 1, further comprising a wearing unit worn on the human body,
wherein the tactile signal application unit is provided on an inner surface of the wearing unit.

6. The remote tactile provision device of claim 5, wherein the tactile signal reception unit receives the tactile signal when a tactile signal request unit requests the tactile signal for the specific object.

7. The remote tactile provision device of claim 1, wherein the tactile signal application unit is provided on one side of a mouse for controlling an indicator displayed on a display, and
the tactile signal reception unit receives the tactile signal of the specific object when a click time of the specific object indicated by the indicator is greater than or equal to a predetermined time.

8. The remote tactile provision device of claim 7, wherein the tactile signal application unit is provided in a click unit of the mouse.

9. The remote tactile provision device of claim 1, further comprising a tactile signal amplification unit for amplifying the tactile signal according to a predefined reference,
wherein the tactile signal application unit provides the amplified tactile signal to a skin.

10. A remote tactile database comprising:
a tactile data set configured as a pair of information associated with an object identifier indicating at least one object and an electrical signal causing a tactile sensation of an object for each object.

11. A method for generating a remote tactile database, the method comprising:
a first step of sensing a signal caused from a tactile sensation of an object; and
a second step of converting the sensed signal into a tactile signal, which is recognized as the tactile sensation of the object when the tactile signal is applied to a skin.

12. The method of claim 11, wherein the tactile signal obtained through the conversion selectively stimulates, among a tactile receptor of a human body and a nerve connected to the tactile receptor, the nerve except for the tactile receptor.
